(19) United States
(12) Patent Application Publication
(10) Pub. No.: US 2006/0226661 A1
(43) Pub. Date: Oct. 12, 2006

(54) Power closure latch assembly

(76) Inventor: Paul Moore, Birmingham (GB)

Correspondence Address: CARLSON, GASKEY & OLDS, P.C., 400 WEST MAPLE ROAD, SUITE 350, BIRMINGHAM, MI, 48009, US

(21) Appl. No.: 11/389,520

(22) Filed: Mar. 24, 2006

(30) Foreign Application Priority Data
Mar. 24, 2005 (GB) GB0506023.1

(51) Int. Cl. E05C 3/06

(52) U.S. Cl. 292/216

(57) ABSTRACT

A latch assembly includes a latch bolt for engaging an associated striker. The latch bolt has an open position, a safety position and a closed position, which positions correspond to an open condition, a safety condition and closed condition, respectively, in the latch assembly. The latch assembly further includes a pawl for releasably retaining the latch bolt in the safety position and the closed position. The latch assembly includes a power closure mechanism that applies a drive load to the latch bolt to drive the latch bolt from the safety position to the closed position and a pivotably mounted driving member with a first portion which in use abuts against the latch bolt in response to powered closure. The powered closure results from movement of the pivot of the driving member combined with abutment of a second portion of the driving member against a bearing surface.

REFERENCE TO RELATED APPLICATIONS

This application claims priority to United Kingdom Patent Application GB 0506023.1 filed on Mar. 24, 2005.

### BACKGROUND OF INVENTION

The present invention relates to latches, and in particular, but not exclusively, to vehicle door latches.

Known vehicle doors include elastomeric door seals secured to a periphery of the door which are compressed when the doors close and the seals come into contact with the periphery of a door aperture. Modern trends in automobile manufacture require high door seal loads to reduce wind generated noise when the vehicle is moving. As a result, increased force must be applied to the door when closed by the operator in order to ensure that the latch mechanism has secured the door shut.

A consequence of higher seal loads is that the operator is required to apply an increasingly high load to the door in order to ensure the latch secures the door shut. A known solution to this problem is to provide a power closing latch mechanism which drives the latch from a latched safety position, also known as a first safety position (achieved by the operator gently closing the door), to a fully latched position. In this way, the shut load (the load required to compress the door seals and to drive the latch to the closed condition) is overcome by the power actuator, rather than the operator. However, existing latches have been known to fail during the power close operation, rendering impossible the subsequent manual opening of the door latch by the operator.

Existing solutions to this problem employ fail safe mechanisms, which require additional components and which add to the complexity and cost of the design, thereby further increasing the risk of component failure.

Furthermore, traditional fail safe mechanisms operate by manually disengaging a power drive from the latch mechanism. Typically, this will require the operator to overcome the load generated between the power drive and the latch bolt, which itself is relatively high since this load must overcome the shut load. This can result in unacceptably high manual release loads to open the door under failure conditions.

In order to over come these high loads, known latches employ long lever arms to generate sufficient force to close the latch. This results in larger latches which require a sizeable space envelope in the door and add weight to the door.

### SUMMARY OF INVENTION

An object of the present invention is to provide an improved form of a latch arrangement which at least mitigates the problems outlined above. A further object is to provide a simple and/or easily operable way of disengaging a power closure mechanism for a latch in the event of failure. A further object of the present invention is to provide a drive mechanism for a power closure latch assembly which provides a more space efficient method of driving the latch assembly.

Thus, the present invention provides a latch assembly including a latch bolt for engaging an associated striker, the latch bolt having an open position, a safety position and a closed position. The positions correspond to an open condition, a safety condition and closed condition, respectively, in the latch assembly. The latch assembly further includes a pawl for releasably retaining the latch bolt in the safety position and the closed position. The latch assembly also includes a power closure mechanism for applying a drive load to the latch bolt to drive the latch bolt from the safety position to the closed position. The power closure mechanism further includes a pivotably mounted driving member with a first portion which in use abuts against the latch bolt in response to powered closure, where the powered closure results from movement of the pivot of the driving member combined with abutment of a second portion of the driving member against a bearing surface or support. Thus, withdrawal of the bearing surface so that it cannot in use abut the driving member provides a simple way of severing the drive path between the power closure mechanism and the driving member in the event of failure, etc. This has the advantage of allowing a user to readily open the latch in the event of an emergency, etc.

Preferably, a clutch stop lever is arranged for escapable engagement with the power closure mechanism. The power closure mechanism may have an actuable state in which the clutch stop lever is engageable with the power closure mechanism, and an escaped state in which the clutch stop lever is not engageable with the power closure mechanism. The power closure mechanism may provide a support for supporting the driving member when the clutch stop lever is engaged with the power closure mechanism to allow the driving member to drive the latch bolt. The driving member may be supported by the support when the clutch stop lever is disengaged from the power closure mechanism to allow retraction of the driving member from the latch bolt.

Preferably, the power closure mechanism includes a power drive lever pivoted about an axis of rotation and having a first end which pivotally carries the driving member and a second end for cooperation with a power actuator.

The power closure mechanism may further include a block lever pivotally mounted about the axis of rotation, the block lever defining the support at a first end.

The interaction of the driving member and the support may be such that engaged movement of the driving member about the block lever upon movement of the power drive lever causes a gearing between the power drive lever and an output of the driving member.

The support may be a cam surface, and the gearing is created by rotating the driving member by its interaction with the cam surface. The support may also be a set of gear teeth, and the driving member defines a cooperating set of gear teeth. The gearing created by the driving member rotates by interaction of the respective sets of gear teeth.

The block lever may have a second end which engages the clutch stop lever when the power closure mechanism is in the actuable state.

Preferably, the driving member has a first arm which defines an output for engaging the pawl and a second arm which carries a drive member spring. The drive member is urged out of engagement with the latch bolt by the drive member spring when the power closure mechanism is in the escaped state.

The driving member may have a second arm which carries a drive member spring. The drive member is urged out of engagement with the latch bolt by the drive member spring when the power closure mechanism is in the escaped state.

Preferably, the clutch stop lever is rotatable with the pawl.

The drive path between a power actuator and the driving member is preferably carried by the power closure mechanism. The clutch stop lever is preferably remote from the drive path.

According to a second aspect of the present invention, a latch assembly includes a latch bolt for engaging an associated striker. The latch bolt has an open position, a safety position and a closed position, which positions correspond to an open condition, a safety condition and closed condition, respectively, in the latch assembly. The latch assembly further includes a pawl for releasably retaining the latch bolt in the safety position and the closed position. The latch assembly includes a power closure mechanism having a retractable driving member for applying a drive load to the latch bolt to drive the latch bolt from the safety position to the closed position. A direction of retraction of the driving member from the latch bolt is substantially parallel to the direction of the drive load, and retraction of the driving member permits opening of the latch.

The optional features recited above in respect of the first mentioned aspect of the invention also apply to the second aspect.

According to a further aspect of the present invention, a drive mechanism for a power closure latch assembly includes a drive lever driveable by a power drive and which carries a rotatable driving member. The driving member has an output for driving a latch bolt. The assembly further includes a stop for cooperating, in use, with the driving member, such that engaged movement of the driving member about the stop upon movement of the drive lever rotates the output relative to the drive lever to drive the latch bolt.

### BRIEF DESCRIPTION OF THE DRAWINGS

The invention will now be described by way of example only, and with reference to the following drawings, in which:

FIG. 1 is a schematic representation of a first embodiment of a latch assembly according to the present invention, with the latch assembly in the open condition;

FIG. 2 is a schematic view of the latch assembly of FIG. 1, with the latch bolt in the safety position;

FIG. 3 is a schematic view of the latch assembly of FIG. 2, with the power drive lever actuated to engage the closure lever with the latch bolt;

FIG. 4 is a schematic view of the latch assembly of FIG. 3, with the power drive lever further actuated to engage the closure lever with the clutch lever and the latch bolt;

FIG. 5 is a schematic view of the latch assembly of FIG. 4, with the power drive lever further actuated to engage the clutch lever with the lever clutch lever stop;

FIG. 6 is a schematic view of the latch assembly of FIG. 5, with the power drive lever further actuated leaving the latch bolt in the closed position;

FIG. 7 shows the latch assembly of FIG. 1, with the power drive lever mid-way to being returned to its rest position and the latch bolt released by the pawl during attempted opening of the latch;

FIG. 7A shows a manual release element that operates a pawl and a clutch stop lever;

FIG. 8 is a schematic view of a second embodiment of latch assembly according to the present invention, with the latch assembly shown in solid lines in a condition corresponding to that shown in FIG. 7;

FIG. 8A shows a manual release element that operates a clutch lever stop arm to operate a pawl;

FIG. 8B shows a manual release element that acts on a pawl to operate a clutch lever stop arm;

FIG. 9 is a schematic view of a third embodiment of latch assembly according to the present invention, with the latch bolt in the safety position;

FIG. 9A shows a manual release element that operates a release lever to release a clutch lever stop arm and release a pawl;

FIG. 10 is a schematic view of the latch assembly of FIG. 9, with the power drive lever actuated to engage the closure lever with the latch bolt;

FIG. 11 is a schematic view of the latch assembly of FIG. 10, with the power drive lever further actuated to move the latch bolt to the closed position;

FIG. 12 is a schematic view of the latch assembly of FIG. 11, with the pawl disengaged from the latch bolt so as to open the latch assembly;

FIG. 13 is a schematic view of the latch assembly of FIG. 12, with the power drive lever in the rest position and the latch bolt in the open position;

FIG. 14 is a schematic view of a fourth embodiment of latch assembly in accordance, with the present invention with the latch bolt in the safety position;

FIG. 14A shows a manual release element that acts on a release lever to release a clutch lever stop arm to release a pawl; and

FIG. 15 is a schematic view of a drive mechanism according to the present invention.

### DETAILED DESCRIPTION OF THE PREFERRED EMBODIMENT

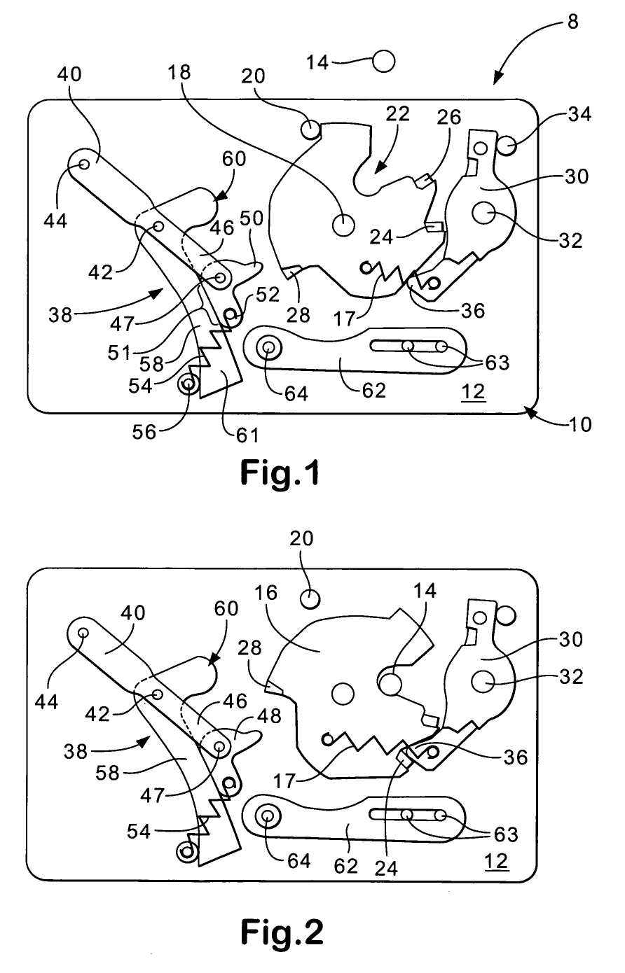

In FIG. 1, a latch arrangement 8 includes a latch assembly 10 and an associated striker 14. The latch assembly 10 is mounted on a latch chassis 12. Typically, the latch chassis 12 would be mounted in a door of a vehicle, which is not shown for clarity. The striker 14 is typically mounted on a vehicle body (also not shown for clarity) and is engaged in use by the latch assembly 10 to close the door, as will be described further shortly.

The latch assembly 10 includes a latch bolt 16 mounted for rotation on a latch bolt pivot 18. The latch bolt 16 is biased to rotate in a counter-clockwise direction by a latch spring 17 and is prevented from rotating past the position shown in FIG. 1 by a latch bolt stop 20. The latch bolt 16 has a mouth 22 for receiving the striker 14, a safety abutment 24 and a closure abutment 26. The latch bolt 16 further includes a drive abutment 28, the purpose of which will be discussed in further detail shortly.

The latch assembly 10 has a pawl 30 which is mounted for rotation on a pawl pivot 32 and is rotationally biased in the clockwise direction by the latch spring 17. A pawl stop 34 prevents clockwise rotation of the pawl 30 beyond its position shown in FIG. 1. The pawl 30 defines a pawl tooth 36 for engagement with the safety abutment 24 and the closure abutment 26 of the latch bolt 16, as will be described further shortly.

The latch assembly 10 includes a power closure mechanism 38. The power closure mechanism 38 includes a power drive lever 40 which is rotatably mounted on a power drive lever pivot 42. The power drive lever 40 has a first end 44 which is driveable by a power actuator (not shown) such as an electric motor, or hydraulic or pneumatic actuator. The power actuator drives the power drive lever 40 by way of a bowden cable or similar known method. The power drive lever 40 has a second end 46 which supports, by pivot 47, an L-shaped driving member in the form of closure lever 48. The closure lever 48 has a first arm defining an output in the form of a drive tooth 50 and a second arm defining a pin 52 for retaining the first end of a closure lever spring 54. The second end of the closure lever spring 54 is fixed to the latch chassis 12 by a spring fixture 56. The second arm also defines an engagement surface 51, the function of which will be described below.

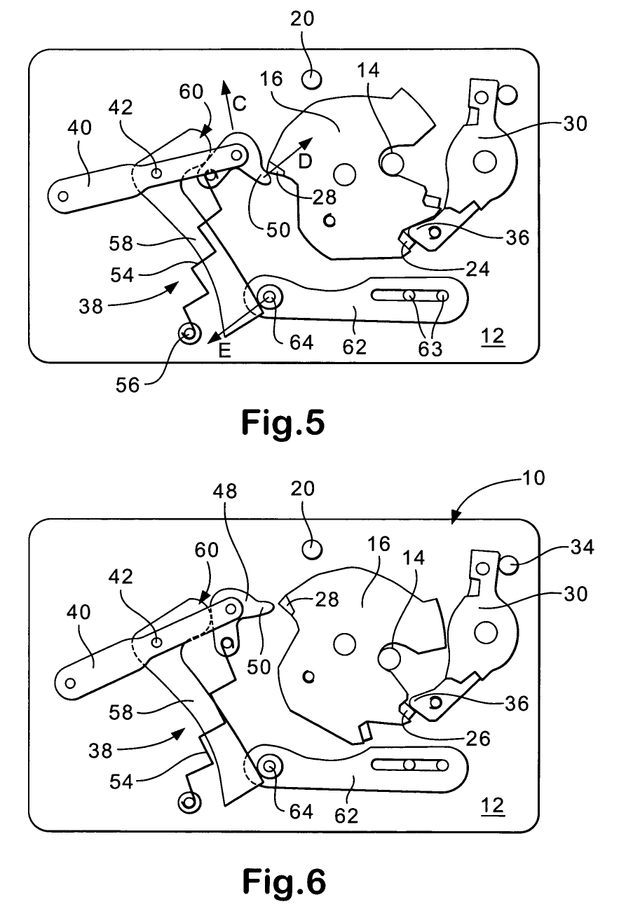

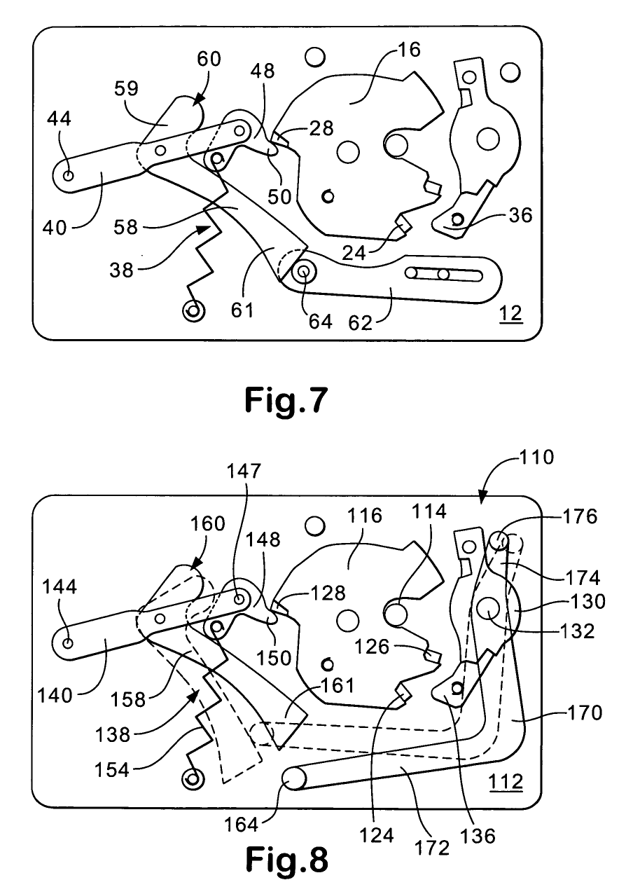

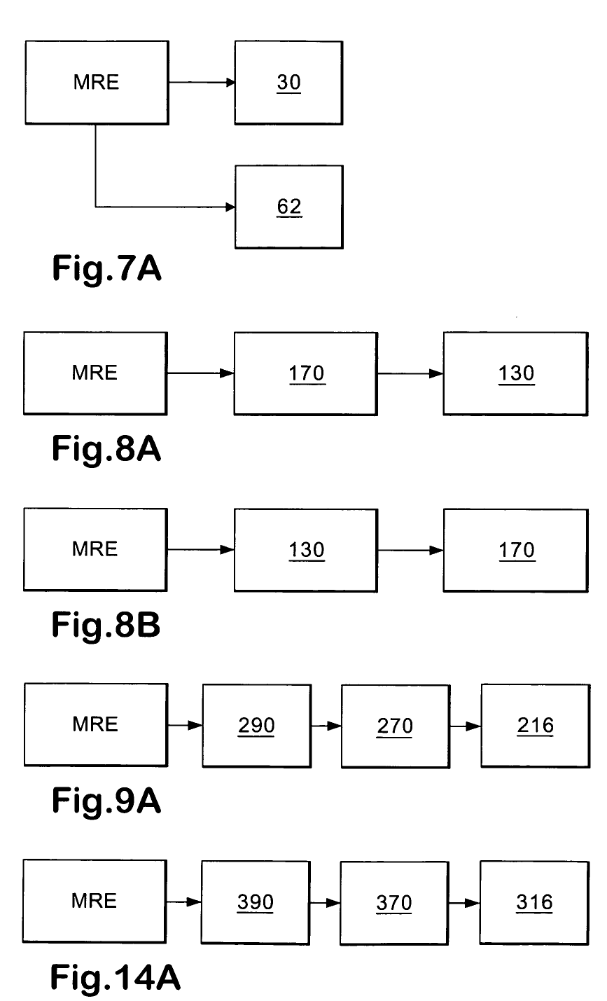

In addition to the power drive lever 40, a block lever in the form of clutch lever 58 is also provided for rotation about the power drive lever pivot 42. The clutch lever 58 has a first arm 59 defining a support means in the form of bearing surface 60 for engagement, in use, with the engagement surface 51 of the closure lever 48, as will be described further shortly. The clutch lever 58 has a second arm 61 provided for engagement with a clutch lever stop 62. The clutch lever stop 62 engages the clutch lever 58 by way of a stop pin 64. The clutch lever stop 62 is moveable between a stop position shown in FIGS. 1 to 6 and a release position shown in FIG. 7. The clutch lever stop 62 is moveable between these two positions by sliding over slide pins 63. In its stop position (FIGS. 1 to 6), the stop pins 64 prevents counter-clockwise rotation of the clutch lever 58 beyond the position shown in FIGS. 5 and 6. However, once the clutch lever stop 62 has been moved to the release position as shown in FIG. 7, the second arm 61 of the clutch lever 58 is allowed to rotate in a counter-clockwise direction past the stop pin 64. The purpose of the engagement and disengagement of the clutch lever stop 62 with the clutch lever 58 will be explained in further detail shortly.

In FIG. 1, the latch assembly 10 is shown in the open condition, with the latch bolt 16 in the open position. The striker 14 is close to the latch bolt 16, which indicates that the associated door is approaching the car body, although the door is not yet closed.

In use, the latch arrangement 8 operates in the following manner. As the operator closes the door of the vehicle, the latch assembly 10 (which is mounted in the vehicle door) moves towards the striker 14 (situated in the car body). With the latch assembly 10 in the open condition shown in FIG. 1, the operator has moved the car door sufficiently far that the mouth of the striker 14 is in close proximity to the striker 14. With a further push of the door towards the car body, the mouth 22 of the latch bolt 16 will receive the striker 14, which will cause the latch bolt 16 to rotate in a clockwise direction. This rotation of the latch bolt 16 causes the pawl tooth 36 to ride up the periphery of the latch bolt 16 to a position proximate the safety abutment 24. Under bias of the latch spring 17, the pawl 30 rotates in a clockwise direction so that the pawl tooth 36 engages the safety abutment 24, as shown in FIG. 2.

In FIG. 2, the latch bolt 16 is retained by the pawl 30 by way of the engagement of the pawl tooth 36 with the safety abutment 24. The latch assembly 10 is therefore in the safety condition, with the latch bolt 16 in the safety position. The car door is therefore partially closed. The striker 14 is retained by the latch bolt 16, but the latch bolt 16 has not yet moved to the closed position. The power closure mechanism 38 has not yet been actuated, and the latch assembly 10 has achieved the safety condition by conventional manual closure of the door by an operator.

With the latch assembly 10 in the safety condition, as shown in FIG. 2, the operator does not need to further operate the door in order for the door to fully close. Full closure of the door is achieved by the power closure mechanism 38 as follows.

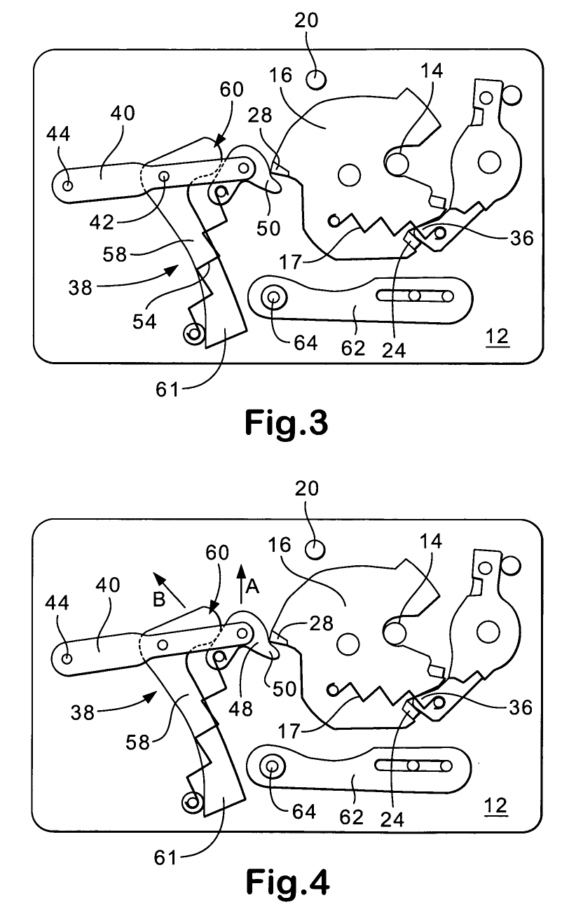

In FIG. 2, the power closure mechanism 38 is in the rest position. The movement of the latch assembly 10 to the safety condition shown in FIG. 2 is detected by a sensor of known type and which is not shown for clarity. The sensor, typically in the form of a microswitch or optical sensor, relays a signal to a central processing unit (CPU) (not shown) to instruct that the latch bolt 16 is in the first safety position. Upon receipt of the signal, the CPU instructs the power actuator (not shown for clarity) to drive the power closure mechanism 38 to move the latch assembly 10 through the positions shown in FIGS. 3, 4, 5 to the closed condition (see FIG. 6). The power closure mechanism 38 operates in the following manner.

The first end 44 of the power drive lever 40 is driven by the power actuator to rotate the power drive lever 40 in a counter-clockwise direction. This causes the second end 46 of the power drive lever 40 to rotate the closure lever 48 to a position where the drive tooth 50 picks up the drive abutment 28, as shown in FIG. 3. The pick up is ensured by the closure lever spring 54, which biases movement of the closure lever 48 to present the drive tooth 50 in a position proximate the drive abutment 28. Further rotation of the power drive lever 40 causes the engagement surface 51 of the closure lever 48 to engage the bearing surface 60 of the clutch lever 58, as shown in FIG. 4.

Continued rotation of the power drive lever 40 drives the closure lever 48 in direction A, as shown in FIG. 4. A load is thereby transferred from the engagement surface 51 of the closure lever 48 to the clutch lever 58 via the bearing surface 60. This load exerts a force in the direction B in FIG. 4, which causes the clutch lever 58 to rotate about the drive lever pivot 42 in a counter-clockwise direction to the position shown in FIG. 5. This rotation causes the second arm of the clutch lever 58 to come into contact with the stop pin 64 of the clutch lever stop 62, thereby preventing further counter-clockwise rotation of the clutch lever 58.

Upon further driving of the power drive lever 40 in the counter-clockwise direction, the power closure mechanism 38 moves from the position shown in FIG. 5 to the position shown in FIG. 6. This stage of power closure occurs as follows.

Counter-clockwise rotation of the power drive lever 40 beyond the position shown in FIG. 5 creates a drive path between the power drive lever 40 and the latch bolt 16 via the closure lever 48. The power drive lever 40 exerts a load on the closure lever 48 in the direction annotated C in FIG. 5. Since counter-clockwise rotation of the clutch lever 58 is prevented by its engagement with the stop pin 64 of the clutch lever stop 62, further driving of the power drive lever 40 results in a load being applied to the drive abutment 28 by the drive tooth 50 in the direction annotated D in FIG. 5. Since the clutch lever 58 is prevented from rotating via the stop pin 64 and the closure lever 48 is prevented from rotating in a clockwise direction by the bearing surface 60 of the clutch lever 58, the closure lever 48 is caused to rotate in a counter-clockwise direction, which causes the load D to drive the latch bolt 16 in a clockwise direction from the position shown in FIG. 5 to the closed position shown in FIG. 6. In this way, the driving of the power drive lever 40 causes the engagement surface 51 of the closure lever 48 to be driven about the bearing surface 60. This in turn causes the drive tooth 50 to move in a counter-clockwise direction and drives the latch bolt 16 in a clockwise direction via the drive abutment 28.

The action of driving the closure lever 48 (via its engagement surface) about the bearing surface 60 causes additional gearing between the power drive lever 40 and the drive tooth 50 by virtue of the rotation generated in the closure lever 48 as a result of its rotation about the second end 46 of the power drive lever 40. Thus, the comparison between FIGS. 5 and 6 show that the power drive lever 40 has rotated 11 degrees counter-clockwise when moving from the FIG. 5 position to the FIG. 6 position, whereas the drive tooth 50 has rotated 35 degrees counter-clockwise when moving from the FIG. 5 position to the FIG. 6 position. This 35 degree counter-clockwise rotation includes 11 degrees of counter-clockwise rotation by virtue of the fact that the closure lever 48 is mounted on the power drive lever 40 which itself has rotated 11 degrees counter-clockwise, but also because the closure lever 48 rotates 25 degrees counter-clockwise relative to the power drive lever 40.

It is conceivable within the scope of the invention that the gearing may be generated by way of inter-engaging sets of gear teeth on each of the bearing surface and dog clutch, respectively.

The advantage of this gearing is that the distance between the power drive lever pivot 42 and the latch bolt pivot 18 can be reduced since the movement required in the drive tooth 50 to drive the latch bolt 16 can be achieved using a shorter power drive lever 40. If the closure lever 48 was not caused to rotate about the bearing surface 60 of the clutch lever 58, a far longer power drive lever 40 would be required in order to achieve the required movement in the drive tooth 50.

As the driving of the power drive lever 40 continues towards the position shown in FIG. 6, the latch bolt 16 is rotated sufficiently far in a clockwise direction to allow the pawl tooth 36 to engage the closure abutment 26. The latch assembly 10 is then in a closed condition with the striker 14 retained within the latch bolt mouth 22. The power closure mechanism 38 is then powered to return to its rest state shown in FIGS. 1 and 2. Alternatively, the closure lever spring 54 may be powerful enough to return the power closure mechanism 38 to the rest position.

Should the operator subsequently wish to open the door, the latch assembly 10 is simply operated in a conventional manner (via a door handle for example) to disengage the pawl tooth 36 from the closure abutment 26. This allows counter-clockwise rotation of the latch bolt 16 to release the striker from the latch bolt mouth 22, thereby opening the door. Subsequent closure of the door is as described above with reference to FIGS. 1 to 6.

Described above is the normal mode of operation of the latch assembly 10. In this manner, the associated door may be opened and closed repeatedly. Throughout the operation of the latch assembly 10 described above, the power closure mechanism 38 has remained in an actuable state, i.e., it is moveable between its rest position (FIG. 1), the safety position (FIG. 5) and the closed position (FIG. 6) repeatedly to allow opening and closing of the door. The clutch lever stop 62 has remained in the stop position, allowing engagement of the stop pin 64 with the clutch lever 58 when the latch assembly 10 is driven to the closed condition. Such engagement has in turn ensured the bearing surface 60 is able to support the closure lever 48 when the latch bolt 16 is moved to the closed position.

However, there may be occasions where the power closure mechanism 38 fails partially through the closing sequence. For example, at the FIG. 5 position with the closure lever 48 obstructing movement of the latch bolt 16, it is clearly necessary to provide the latch assembly 10 with a manual override to allow the door to be opened. Such a contingency is provided for as follows.

With reference to FIGS. 7 and 7A, under operation of one of the manual door release elements (MRE), for example an inside door handle or outside door handle, the pawl tooth 36 has disengaged from the closure abutment 26. Such operation is shown schematically in FIG. 7A in which a manual release element (MRE) acts on the pawl 30 to release the latch bolt 16 and simultaneously operates on the clutch lever stop 62 to allow the power closure mechanism 38 to move to the escaped state. Additionally, and importantly, operation of the manual release element (MRE) has also moved the clutch lever stop 62 from the stop position shown in FIGS. 1 to 6 to the release position. This movement has caused the stop pin 64 to release the clutch lever 58, allowing it to rotate in a counter-clockwise direction from the position shown in FIGS. 1 to 6 to the position shown in FIG. 7. In turn, this movement has freed the closure lever 48 from the bearing surface 60 of the clutch lever 58, allowing the latch bolt 16 to drive the closure lever 48 in a clockwise direction under action of the latch spring 17. This drives the drive tooth 50 out of the way of the drive abutment 28, and the latch bolt 16 continues to rotate in the counter-clockwise direction. The power closure mechanism 38 has escaped the clutch lever stop 62, and the drive abutment 28 and has therefore moved from the actuable state described above to an escaped state. With the power closure mechanism 38 in this escaped state, the latch bolt 16 is permitted to release the striker 14, thereby opening the door.

Returning briefly to FIG. 5, the load E reacted by the stop pin 64 under action of the second arm 61 of the clutch lever 58 is significantly less than the load D applied by the drive tooth 50 to the closure abutment 26. The advantage of this is that the manual effort required to disengage the stop pin 64 from the clutch lever 58 is substantially less than that which would be required to disengage the drive tooth 50 from the closure abutment 26. Even under power closure failure conditions, the operator does not experience any significant difference in the operation of the manual release element to open the door. This is because the point of escapement of the power closure mechanism 38 is between the clutch stop lever 62 and the clutch lever 58 and as such is not within the drive path between the power actuator and the latch bolt 16. This allows the drive tooth 50 to retract from the drive abutment 28 in the same plane as the load D. Thus, the friction between the drive tooth 50 and the drive abutment 28 need not be overcome to open the latch bolt 16.

FIG. 8 shows a second embodiment of latch assembly 110, with components in common with the first embodiment of the latch assembly 10 numbered 100 greater. The difference between the first and second embodiments of the latch arrangement is the replacement of the clutch lever stop 62 of the first embodiment with the clutch lever stop arm 170 in the second embodiment. The clutch lever stop arm 170 is pivoted for rotation about the pawl pivot 132 and has an L-shaped first arm 172 and a shorter second arm 174. The first arm 172 defines a stop pin 164 which is provided to engage and disengage the clutch lever 158 to change the state of the power closure mechanism 138 between the actuable state and the escaped state in a similar fashion to the stop pin 64 in the first embodiment. The shorter second arm 174 of the clutch lever stop arm 170 defines a pawl abutment 176. The pawl abutment 176 acts on the pawl following operation of a manual release element to disengage the pawl tooth 136 from the closure abutment 126 to allow the latch bolt 116 to release the striker 114. Reference to FIG. 8A shows schematically a manual release element (MRE) which operates the clutch lever stop arm 170, which in turn operates the pawl 130 to open the latch.

Within the scope of the invention, it is possible for the manual release element to act on the pawl, which in turn operates the clutch lever stop arm 170. This is shown schematically in FIG. 8B.

Operation of the second embodiment of the latch assembly 110 is similar to the first embodiment in that operation of a manual release element (such as an inside release handle) following failure of the power closure mechanism 138 to disengage the pawl 130 from the latch bolt 116 causes displacement of the stop pin 164 to allow counter-clockwise rotation of the clutch lever 158. This counter-clockwise rotation allows for retraction of the drive tooth 150 from the path of the closure abutment 126 upon rotation of the latch bolt 116 to release the striker 114. The movement of the stop pin 164 to release the clutch lever 158 to move the power closure mechanism 138 to the escaped state is achieved as follows. When the manual release element is activated by the operator, the pawl 130 is caused to rotate in a counter-clockwise direction, which disengages the pawl tooth 136 from the closure abutment 126. Since the clutch lever stop arm 170 is mounted for rotation with the pawl 130 about the pawl pivot 132, the clutch lever stop arm 170 is also rotated in a counter-clockwise direction, which moves the stop pin 164 from the dashed position to the solid line position, as shown in FIG. 8. Operation of the second embodiment of the latch assembly 110 is otherwise substantially similar to that of the first embodiment of latch assembly 10, as described above.

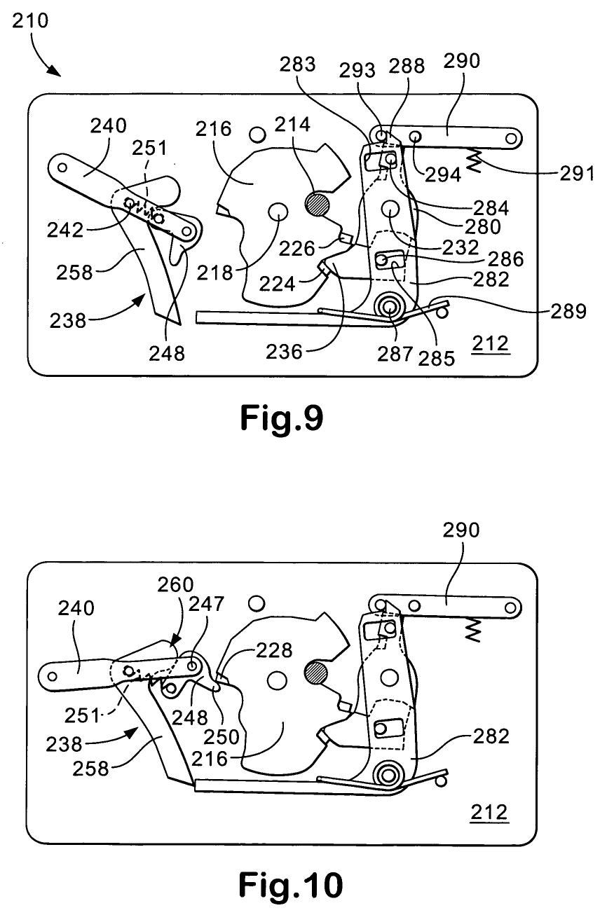

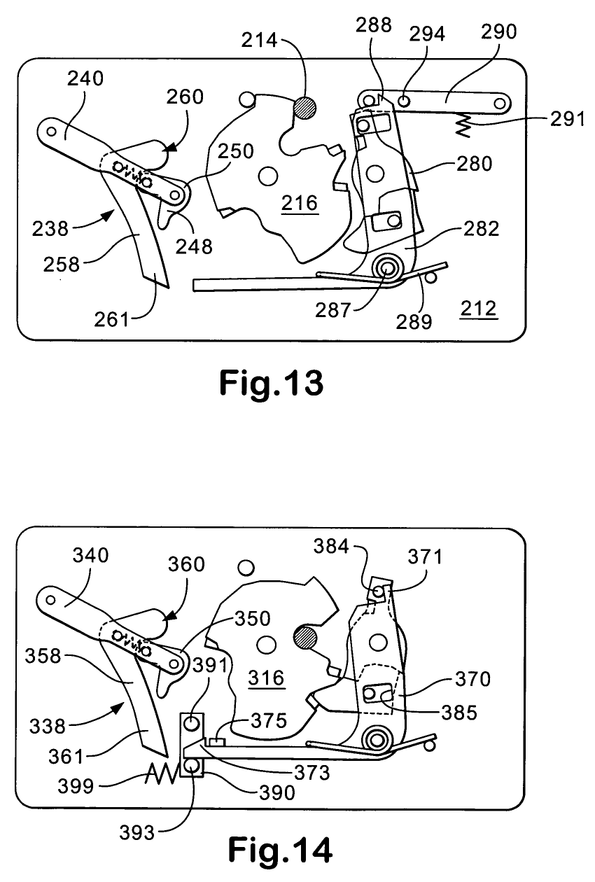

In FIGS. 9 to 13, a third embodiment of a latch assembly 210 is shown with components in common with the first embodiment of latch arrangement 10 numbered 200 greater.

A power drive lever 240 and a closure lever 248 differ from the first two embodiments in that the closure lever spring 251 is attached to power drive lever pivot 242 and not to a separate spring fixture as in the first and second embodiments. The latch bolt 216 differs slightly in profile from the first and second embodiments, but is identical in terms of the relative position of the abutments 224, 226 and 228. However, the pawl 280 and the clutch lever stop arm 282 differ from the earlier embodiments, both in their physical features and their mode of operation, as follows.

The pawl 280 is pivoted about a pawl pivot 232 and defines a pawl tooth 236. Unlike earlier embodiments, the pawl 280 further defines an upper pawl stop 284 and a lower pawl stop 286. The clutch lever stop arm 282 has a first arm for engagement with the clutch lever 258, a second arm which defines an upper aperture 283 for receiving the upper pawl stop 284, a lower aperture 285 for receiving the lower pawl stop 286 and a release detent 288. The clutch lever stop arm 282 is pivoted about a pivot 287 and is biased for rotation in the counter-clockwise direction by a clutch lever stop arm spring 289. The latch assembly 210 includes a release lever 290 pivoted about a pivot 294 and rotationally biased by a release lever spring 291. Arranged at a first end of the pivoted release lever 290 is a release lever stop 293. Under action of the release lever spring 291, the release lever stop is biased towards the clutch lever stop arm 282. In this manner, with the pivoted release lever 290 in the position shown in FIG. 9, the release lever stop 293 retains the clutch lever stop arm 282 in position by way of its engagement with the release detent 288.

Operation of the latch assembly 210 is as follows. In FIG. 9, the latch assembly 210 is in the safety condition, with the power closure mechanism 238 in the rest state. With the latch assembly 210 in this condition, the clutch lever stop arm 282 is biased in a counter-clockwise direction by the clutch lever stop arm spring 289. This biased rotation causes the right hand wall of the upper aperture 283 and the left hand wall of the lower aperture 285 to be urged against the upper pawl stop 284 and lower pawl stop 286, respectively. This causes the release detent 288 to engage the release lever stop 293. The release lever stop 293 is prevented from disengaging the release detent 288 by the action of the release lever spring 291.

To fully close the latch assembly 210, the power drive lever 240 is driven in a counter-clockwise direction to engage the closure lever 248 with the bearing surface 260 of the clutch lever 258. The bearing of the closure lever 248 against the bearing surface 260 causes the driving tooth 250 to engage the driven abutment 228 in a similar way to earlier embodiments.

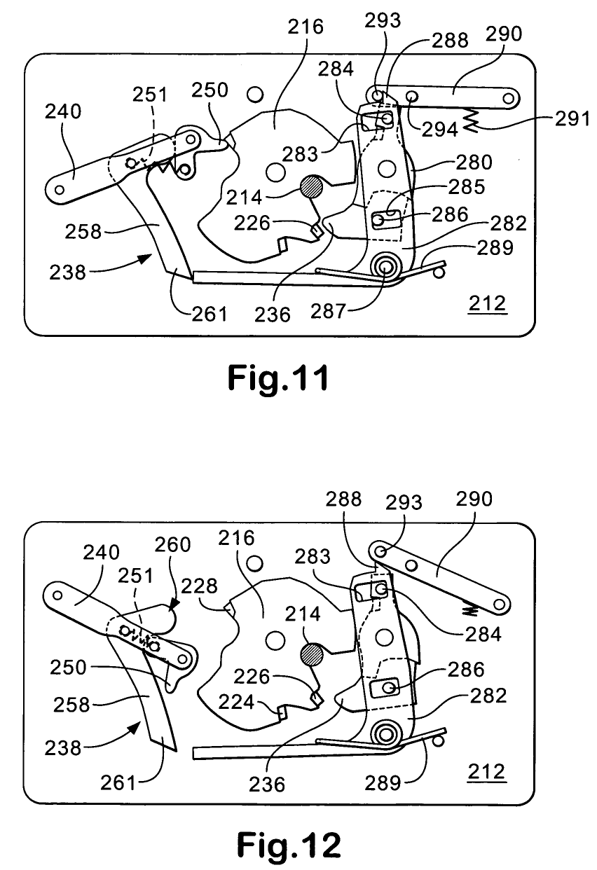

As the power drive lever 240 is driven further, the latch assembly 210 approaches the extreme actuated condition as shown in FIG. 11. In this position, the latch bolt 216 has rotated under action of the latch spring to move the pawl tooth 236 to a position proximate the closure abutment 226. Upon return of the power closure mechanism 238 to the rest state, the latch bolt 216 will be retained in the fully closed position.

In order to subsequently open the door, the operator operates one of the manual release elements (typically an inside door lever or an outside door lever). This operates the release lever 290 to move the release lever stop 293 out of engagement with the release detent 288. This allows the clutch lever stop arm 270 to rotate in a counter-clockwise direction under the clutch lever stop arm spring 289. This rotation of the clutch lever stop arm 270 causes the right hand wall of the upper aperture 283 to engage the upper pawl stop 284, which in turn disengages the pawl tooth 236 from the closure abutment 226. This is shown schematically in FIG. 9A, in which a manual release element 200 operates the release lever 290 which in turn releases the clutch lever stop arm 270, which releases the pawl 230. The latch bolt 216 is therefore able to rotate in a counter-clockwise direction from the position shown in FIG. 12, thereby releasing the striker 214 from the mouth 222 of the latch bolt 216. This releases the striker 214 and leaves the latch assembly 210 in an open condition as shown in FIG. 11.

FIG. 14 illustrates a fourth embodiment latch assembly 310. The latch assembly 310 is similar to the third embodiment of latch assembly 210. However, the clutch lever stop arm 370 and the release lever 390 are different from those of the third embodiment.

The clutch lever stop arm 370 has a lower aperture 385 but has no upper aperture. Instead, the clutch lever stop arm 370 has a pawl driver 371 which acts on an upper pawl stop 384. The extreme end of the first arm of the clutch lever stop arm 370 has an abutment 373 which acts against a stop 375 to prevent further rotation in the clockwise direction from the position shown in FIG. 14.

Upon release of the latch assembly 310, the release lever 390 is rotated about the release lever pivot 391 in a clockwise direction to move a release stop 393 out of engagement with the clutch lever stop arm 370. This allows the clutch lever stop arm 370 to rotate in a counter-clockwise direction, which allows the power closure mechanism 338 to retract the dog clutch 348 in order to allow the latch arrangement to open.

This is shown schematically in FIG. 14A, in which a manual release element 300 acts on the release lever 390 to release the clutch lever stop arm 370 which in turn releases the pawl 316.

Operation of the power closure mechanism in each of the second, third and fourth embodiment operate in substantially the same manner as that of the first embodiment.

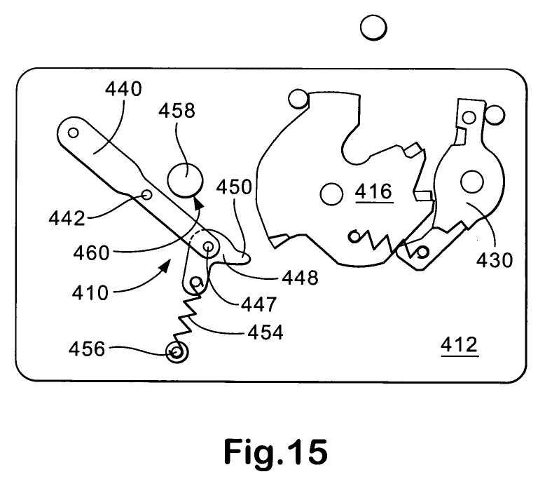

In FIG. 15, a drive mechanism 410 includes a power drive lever 440 which carries a closure lever 448. The power drive lever 440 is pivoted about a power drive lever pivot 442. The drive mechanism 410 includes a closure lever spring 454 for biasing rotation of the closure lever 448. The closure lever spring 454 is grounded to a latch chassis 412 by a spring fixture 456.

The major difference between the drive mechanism 410 and the power closure mechanisms of the previous embodiments is the provision of a stop 458 which is grounded to the latch chassis 412 and is immovable with respect to the power drive lever pivot 442. The stop 458 defines a bearing surface 460 against which the closure lever 448 is rotated in response to operation of the power drive lever 440. The stop 458 acts in a similar manner to the clutch lever of the previous embodiments with the major difference being that the stop 458 does not move with respect to the power drive lever 440 or the closure lever 448.

The drive mechanism 410 cooperates with a latch bolt 416 and a pawl 430 in a manner similar to the previous embodiments of power closure mechanism in order to drive the latch bolt 416 from the safety position to the closed position. The shape of the stop 458 may be other than that shown and still fall within the scope of the invention, provided that the relative relationship of the power drive lever pivot 442, the bearing surface 460 and the closure lever 448 remain constant.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A latch assembly comprising:
a latch bolt for engaging an associated striker, wherein the latch bolt has an open position, a safety position and a closed position corresponding to an open condition, a safety condition and a closed condition, respectively;
a pawl for releasably retaining the latch bolt in the safety position and the closed position; and
a power closure mechanism for applying a drive load to the latch bolt to drive the latch bolt from the safety position to the closed position, wherein the power closure mechanism includes a pivotably mounted driving member having a first portion and a second portion,
wherein the first portion abuts against the latch bolt in response to a powered closure, and wherein the powered closure results from movement of a pivot of the pivotably mounted driving member combined with abutment of the second portion of the pivotably mounted driving member against a bearing surface.

2. The latch assembly of claim 1 where the pivot lies between the first portion and the second portion.

3. The latch assembly of claim 1 wherein the power closure mechanism includes a pivotable power drive lever having a first end which pivotally carries the pivotably mounted driving member and a second end for cooperation with a power actuator.

4. The latch assembly of claim 1 wherein the power closure mechanism further includes a pivotally mounted block lever, and a first end of the pivotally mounted block lever defines the bearing surface.

5. The latch assembly of claim 4 further including a pivotable power drive lever, wherein engaged movement of the pivotably mounted driving member about the pivotally mounted block lever, upon movement of the pivotable power drive lever, causes a gearing between the pivotable power drive lever and an output of the pivotably mounted driving member.

6. The latch assembly of claim 1 wherein the bearing surface is a cam surface, and a gearing is created by rotating the pivotably mounted driving member by interaction with the cam surface.

7. The latch assembly of claim 1 wherein the bearing surface is a set of gear teeth, the pivotably mounted driving member defines a cooperating set of gear teeth and interaction of the set of gear teeth and the cooperating set of gear teeth rotates the pivotably mounted driving member to create a gearing.

8. The latch assembly of claim 1 wherein the pivotably mounted driving member includes a first arm which defines the first portion for engaging the latch bolt and a second arm which carries a drive member spring, and the pivotably mounted drive member is urged out of engagement with the latch bolt by the drive member spring when the power closure mechanism is in an escaped state.

9. The latch assembly of claim 1 further including a clutch stop lever arranged for escapable engagement with the power closure mechanism,
wherein the power closure mechanism has an actuable state in which the clutch stop lever is engageable with the power closure mechanism and an escaped state in which the clutch stop lever is not engageable with the power closure mechanism,
wherein the power closure mechanism provides the bearing surface for supporting the pivotably mounted driving member when the clutch stop lever is engaged with the power closure mechanism to allow the pivotably mounted driving member to drive the latch bolt, and
wherein the pivotably mounted driving member is unsupported by the bearing surface when the clutch stop lever is disengaged from the power closure mechanism to allow retraction of the pivotably mounted driving member from the latch bolt.

10. The latch assembly of claim 9 further including a pivotally mounted block lever, wherein the pivotally mounted block lever includes an end that defines the bearing surface.

11. The latch assembly of claim 9 further including a pivotally mounted block lever, wherein of the pivotally mounted block lever includes an end that engages the clutch stop lever when the power closure mechanism is in the actuable state.

12. The latch assembly of claim 9 wherein the clutch stop lever is rotatable with the pawl.

13. A latch arrangement comprising:
a latch assembly including:
a latch bolt for engaging an associated striker, wherein the latch bolt has an open position, a safety position and a closed position corresponding to an open condition, a safety condition and a closed condition, respectively,
a pawl for releasably retaining the latch bolt in the safety position and the closed position, and
a power closure mechanism for applying a drive load to the latch bolt to drive the latch bolt from the safety position to the closed position, wherein the power closure mechanism includes a pivotably mounted driving member having a first portion and a second portion,
wherein the first portion abuts against the latch bolt in response to a powered closure, and wherein the powered closure results from movement of a pivot of the pivotably mounted driving member combined with abutment of the second portion of the pivotably mounted driving member against a bearing surface; and
a power actuator, wherein a drive path between the power actuator and the pivotably mounted driving member is carried by the power closure mechanism.

14. The latch arrangement of claim 13 further including a clutch stop lever arranged for escapable engagement with the power closure mechanism wherein the clutch stop lever is remote from the drive path.

15. A latch assembly comprising:
a latch bolt for engaging an associated striker, wherein the latch bolt has an open position, a safety position and a closed position corresponding to an open condition, a safety condition and a closed condition, respectively;
a pawl for releasably retaining the latch bolt in the safety position and the closed position; and
a power closure mechanism having a retractable driving member for applying a drive load to the latch bolt to drive the latch bolt from the safety position to the closed position, wherein a direction of retraction of the retractable driving member from the latch bolt is substantially parallel to a direction of the drive load, and retraction of the retractable driving member permits opening of the latch assembly.

16. The latch assembly of claim 15 further including a clutch stop lever arranged for escapable engagement with the power closure mechanism,
wherein the power closure mechanism has an actuable state in which the clutch stop lever is engageable with the power closure mechanism and an escaped state in which the clutch stop lever is not engageable with the power closure mechanism,
wherein the power closure mechanism provides a bearing surface for supporting the retractable driving member when the clutch stop lever is engaged with the power closure mechanism to allow the retractable driving member to drive the latch bolt, and
wherein the retractable driving member is unsupported by the bearing surface when the clutch stop lever is disengaged from the power closure mechanism to allow retraction of the retractable driving member from the latch bolt.

17. A drive mechanism for a power closure latch assembly comprising:
a drive lever driveable by a power drive that carries a rotatable driving member, wherein the rotatable driving member includes an output for driving a latch bolt,
a stop for cooperating with the rotatable driving member such that engaged movement of the rotatable driving member about the stop upon movement of the drive lever rotates the output relative to the drive lever to drive the latch bolt.

18. The drive mechanism of claim 17 wherein rotation of the rotatable driving member about the stop generates a gearing between the drive lever and the output of the rotatable driving member.

19. The drive mechanism of claim 17 further including a block lever including an end that defines a cam surface, wherein the rotatable driving member rotates against the cam surface.

20. The drive mechanism of claim 19 wherein the block lever includes another end that defines a set of gear teeth and the rotatable driving member includes a cooperating set of gear teeth, and the set of gear teeth engage the cooperating set of gear teeth.
